(19) United States
(12) Patent Application Publication
(10) Pub. No.: US 2014/0258168 A1
(43) Pub. Date: Sep. 11, 2014

(54) Automated Pickup & Delivery System

(71) Applicant: Darryl George Crawford, Country Club Hills, IL (US)

(72) Inventor: Darryl George Crawford, Country Club Hills, IL (US)

(21) Appl. No.: 13/789,084

(22) Filed: Mar. 7, 2013

(51) Int. Cl. G06Q 10/08; E05G 1/04

(52) U.S. Cl. CPC G06Q 10/0836; E05G 1/04
USPC 705/339

(57) ABSTRACT

A pickup and delivery system is disclosed wherein packages for service are deposited in drop box. The entity depositing the package receives electronic notification of receipt of the package and the service provider is electronically notified of the package deposit. The service provider is provided with a code to unlock the drop containing the items to be serviced. After the items have be serviced, they are placed in lockboxes and an unlock code is generated for each lockbox. The unlock code is electronically transmitted to the entity requesting service and the processed items are removed from the lockbox in connection with entry of the unlock code information.

### PRIORITY

This application claims priority from provisional patent application 61/634,993, filed Mar. 7, 2012 which is hereby incorporated, in its entirety, by reference.

### BACKGROUND

Multi-unit office buildings and gated communities may encounter problems with package deliveries to tenants, residents or customers/guests of the tenants/residents. As a consequence, package delivery services may attempt to address the problems by to setting up lockers for receipt of items such as packages for receipt and/or delivery of merchandise similar to neighborhood postal boxes.

Drop off and pick up of items for servicing or repair from unmanned or unsecured locations can be further problematic from a security standpoint. For instance, garment cleaners would benefit from a system that would allow a building tenant to leave articles of clothing at a location within the building for pickup by the cleaners. However, a valid concern is that the clothing being let behind would not be secure, Further, privacy concerns might dissuade tenants from leaving clothes unattended for anyone to rummage through . Any business offering pickup of items for servicing or repair would have similar concerns as that outlined above.

### BRIEF DESCRIPTION OF THE DRAWINGS

FIG. 1 is a flowchart illustrating the operation of the pickup and delivery system.

FIG. 2 is a flowchart which illustrates the package delivery process according to the pickup and delivery system.

FIG. 3 is a diagram illustrating components of the disclosed pickup and delivery.

### DESCRIPTION

The foregoing concerns may be addressed by providing one or more containers or bags with a machine readable security tag. Each tag identifier may be assigned to a particular customer in connection with the signup of the customer for service. A drop box may be provided such that items may be deposited within a lidded opening but cannot effectively be removed from the drop box through the opening. Such a box may be similarly constructed in principle to the of a postal mail box.

Since tenants/customers or the like do not receive packages every day, it is not necessary for the lockers to be permanently assigned to individuals, as is the case with current state-of-the-art locker drop off and pickup systems. In fact, it would be better if the lockers were temporarily assigned to individuals as needed, and were subsequently reused by someone else. This drastically reduces the number of lockers that would be needed at each location. Likewise, a system which can accommodate only one delivery service would require other service providers to set up additional locker systems at additional expense and much additional space. The system according to one aspect of the disclosed system herein can accommodate multiple service providers by having multiple drop boxes or bins that can be dynamically assigned as needed thereby also allowing delivery services to deliver packages to one place in multi-unit buildings or complexes. There are fewer drop boxes in each location, and the service providers do not have to go to the trouble of finding a site for another locker system and the expense of installing, operating, and maintaining a locker system which may not be used every day.

### The Drop Box

A drop box for leaving articles, clothing, packages and the like is equipped with communication capability so as to enable electronic notification of the receipt and dispatch of items placed in and removed from the drop box. It should be noted that the term package as used herein throughout is contemplated to include any article or thing placed in the drop box for servicing. Preferably, the drop box will be constructed such that packages may be deposited within a lidded opening but cannot effectively by removed from the drop box through the opening. Such a box may be similarly constructed in principle to that of a postal mail box.

The drop box will have a sensor to detect the absence or presence of a package, for purposes of enabling the notification of receipt and pick up of articles, etc.

A central computer for the system may monitor the status of the drop off box to determine the absence of presence of a package. Optionally, the drop box can be equipped with readers which read package labels and/or package contents if the contents are equipped to interface with readers. Further, optionally, multiple drop boxes may be provided for multiple service providers.

In one embodiment of the disclosed system, a single drop chute with sorting system may be provided for multiple service providers. Optionally, drop box may be interfaced with package readers to insure that a package is dropped into or sorted for the correct service provider. In one preferred embodiment, a drop box may be equipped with a sensor to gather additional information about packages. This sensor may be a scale to determine weight of packages. In one embodiment of the disclosed system, a terminal may be associated with the drop box to allow

entry of shipping details, allow payments and/or generate labels or tags for deposited items.

The foregoing enables secure unattended delivery of packages/items wherein the security can be enhanced through the use of camera monitoring of the unattended drop box/lockbox area.

In connection with servicing the deposited items, an email notification, phone call, text message, etc. may be dispatched to the customer indicating a numbered and secured pickup locker along with the combination needed to open a lock securing the pickup locker or lockbox. The term lockbox as used herein throughout shall refer to a locker having a lock. The interface for the locker/lockbox may comprise a touchpad, a bar code reader, a Simplex locking device, etc. The system through use of a program or through an operator can remotely program unlock codes for the lockers. Further, the delivery service can also be provided with a confirmation from the system that the package was picked up by the intended recipient.

### The Lockbox

Each locker preferably has an electronic locking mechanism that will normally only open when the proper unlock code is entered for a locking mechanism controlling access to the locker. The code physically entered at a touchpad, wirelessly received, etc. Entry of the code can be effected at the locker on-site or remotely. For instance, code entry may occur at a remote computer connected to the lock system or by a system operator. It is contemplated that the unlock code can be replace with or augmented by biometric identification. Each unlock code for each locker can be reprogrammed with a new unlock code by a central computer or by a remote computer. Preferably, each locker has a sensor that will detect the absence or presence of a package. Toward this end, the central computer may be used to monitor the status of each locker to determine the absence or presence of a package. Video surveillance may be used to monitor the lockers. Photos and video snippets may be tagged and stored in a database documenting drop off and pickup events. Each lockbox area or alternatively, each locker may have or may be connected to a transmitter, receiver and processor. A lock mechanism of the locker may be reprogrammed with a code by the processor through the receipt of the coding information by the receiver with may be transmitted from a remote location such as a central computer. Lockbox transmitters may transmit a message indicating that they have been accessed and/or emptied by a customer. In connection with receipt of that transmitted message from the locker, new lock coding information may be transmitted to the locker from remote location (e.g., central computer) so that the locker processer may program the lockbox lock with a new code for the next customer.

Additional features (based on, for instance, customer preference) may include:

A—Readers for reading package labels to confirm that the package is delivered as intended

B—Cameras to capture photo and/or video of the drop off and/or pickup, and associate the photo and/or video with the pickup and/or drop off

C—Sorters to sort dropped off packages by service provider

D—If equipped, read the contents of dropped off packages

E—Weighing dropped off packages

F—Using a single locker location to service multiple service providers

G—Generating labels or tags for packages being dropped off

H—Accepting payment on site or remotely, in addition to advance payment

Remote (or Onsite) Drop box/Lockbox Computer

A computer may be used with the foregoing disclosed system for the purpose of facilitating operations at the drop box/lock box location. The computer may be remotely located from the drop box whereby a local or wide area network may provide a communication channel between the computer and the remotely located locker and drop box. Alternatively, the computer may be located onsite with the lockers and drop box. An interface with the computer may be established with keypads, bar code readers, radio frequency identification (RFID) readers and other peripherals. The computer may be used to open the appropriate locker when the correct unlock input is provided such as the entry of a correct unlock code. Monitoring of the contents of lockers may also be done in connection with the computer. The computer may also be used to monitor the contents of a drop box and used to collect photo and/or video records. The photo and/or video records may be associated with individual drop off and pickup events. The computer may be used to log events such as packages placed in lockers, packages placed in a drop box, and packages being removed form the lockers. The log entries may be stored in a memory. Each log entry may contain a time and date stamp.

Central Computer with System Operator Interface

A central computer with a system operator interface may be provided which is connected to a display that shows the status each drop box to determine the absence or presence of a package. The status of each locker out in the field is also shown on the interface indicating the absence or presence of a package. Log activities for lockers and drop box along with time and date for each event my also be displayed. The operator interface allows the operator to override unlock codes and open any locker; change unlocks code on any locker; maintain a database of users; assign users to lockers; and allow operator to view activity where drop boxes and locker are located for added security.

### Optional Components

The automated pickup and delivery system described herein may make use of the following optional components/services/aspects:

Reading devices at or in each locker (bar code, RFID, etc.) to read package information.

Local computers to enter drop box information.

Camera(s) to record drop off and retrieval of packages for added security

A scale for weighing packages

A terminal for entry of package information at each drop box location

Biometric (fingerprint, face, etc.) recognition

Automatic unlock code generation

Automatic or manual message generation, both to users who have package(s) to pickup, to service providers who have package(s) to pickup, to users who have dropped off package(s), and to service providers who have placed package(s) in lockers for pickup by users.

### Package Drop Off Process:

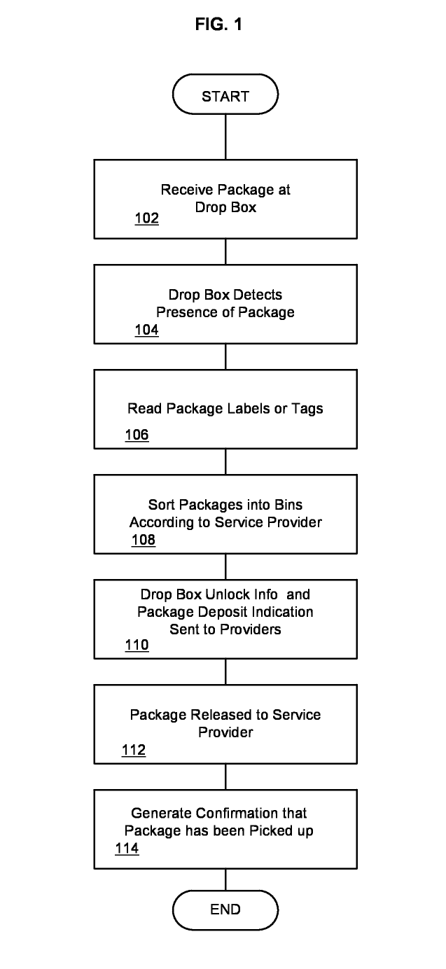

FIG. 1 is a flowchart illustrating the operation of the package drop off process for the pickup and delivery system disclosed herein. With reference to FIG. 1, a package is received in the drop box at step 102. The sender of the package, doorman, attendant, etc. may actually deposit the package into the drop box at this step. The sender Information can be filled out manually or it may be attached to package via a label or tag. As used herein, the term label is contemplated to include all forms of identification for the package whether by tag, RFID, etc. The package information may also be entered at a computer or computer terminal located onsite with the drop box and or lockboxes. In one embodiment of the pickup and delivery system disclosed herein, the sender information is entered online (if entered online, the sender will be in possession of a drop off code or equivalent in advance of the deposit). At step 104 of FIG. 1, the drop box detects presence of package and the central computer notifies the service provider. The detection may be accomplished by any known sensing device whether it be a detector employing a camera, switch, etc. At step 106, the read package labels or tags are read and the pertinent service providers are notified of the order for the requested service. Consequently, the package containing shoes with the order requesting shoe repair is sent to the cobbler and the order for dry cleaning is sent to the cleaners. As can be appreciated, multiple services can make use of the delivery and pickup system disclosed herein which may optionally sort packages into bins according to service provider for multiple service providers as shown at step 108. The sorting may be accomplished using well-known sorting technology and the sorting of articles may be provided on-site. At step 110, for multiple provider sites, unlock information (signals, etc.) is provided to the appropriate service provider. The package is released to the service provider and the service provided picks up its designated package at step 114. Consequently, in the case of a multiple drop box system, a service provider is granted access to the drop box or bin for that service provider. At step 114, the delivery and pickup system generates an confirmation to the sender of the package via, for instance, electronic notification (text, IM, email, etc.) that the package has been picked up along with other information such as price, weight, expected delivery date, etc.

### Package Delivery Process:

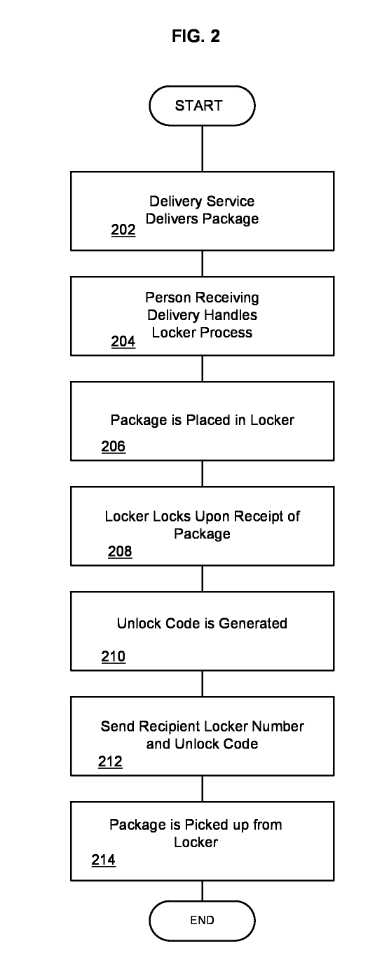

FIG. 2 is a flowchart which illustrates the package delivery process according to the pickup and delivery system disclosed herein: At step 202, a delivery service delivers the package after the contents have been processed, e.g. clothes have been cleaned, shoes have been repaired, etc. The delivery may entail, for instance, a delivery person delivering the package to a person associated with a building service business etc. such as a doorman, receptionist or attendant. From this point, the person receiving delivery of the package handles the locker process at step 204. At step 206 information is entered into the locker system into the remote (or onsite) drop box/lockbox computer by a doorman, receptionist, etc. The input of the package information can be scanned off of a package label to be read at the remote (or onsite) drop box/lockbox computer. The inputted information may include the locker number of the package deposit. A portable device may be used to accomplish the input of information into the computer. Alternatively, the delivery person , receptionist, etc. can enter the package information manually. At step 206 the package is placed in a locker in connection with the remote (or onsite) drop box/lockbox computer causing an assigned locker to unlock. Optionally, a reader in locker reads package information and sends information to local computer. At step 208, the locker containing the packages automatically locks when door is closed. It should be noted that where no drop box/lockbox computer is present, the central computer may interface directly with lockers and bins thru network, radio, and/or phone signaling. At step 210 an unlock code is generated for the locker having the package with processed article(s). The unlock code may be generated by the remote (or onsite) drop box/lockbox computer or alternatively, by the central computer. At step 212 the recipient (e.g., the customer) of the requested service is sent a message with the locker number of the locker containing the package as well as the unlock code for the locker. The message may take the form of, for instance, a text message, instant message (IM), email message, voice message, etc. The message with the locker number and unlock code may be sent from a number of sources. These sources include, the remote (or onsite) drop box/lockbox computer, central computer, the locker or even the delivery company delivering the package with the processed articles. At step 214, the package is picked up from the locker in connection with the unlock code being used to unlock the locker. The unlock code is contemplated as being entered through an electronic device such as a mobile phone. Alternatively, the unlock code may be entered manually. The recipient of the code may enter the unlock information or the entity operating the locker service may unlock the locker by request in connection with receiving the unlock code from the message recipient. Cameras may be employed to document removal of items from lockers.

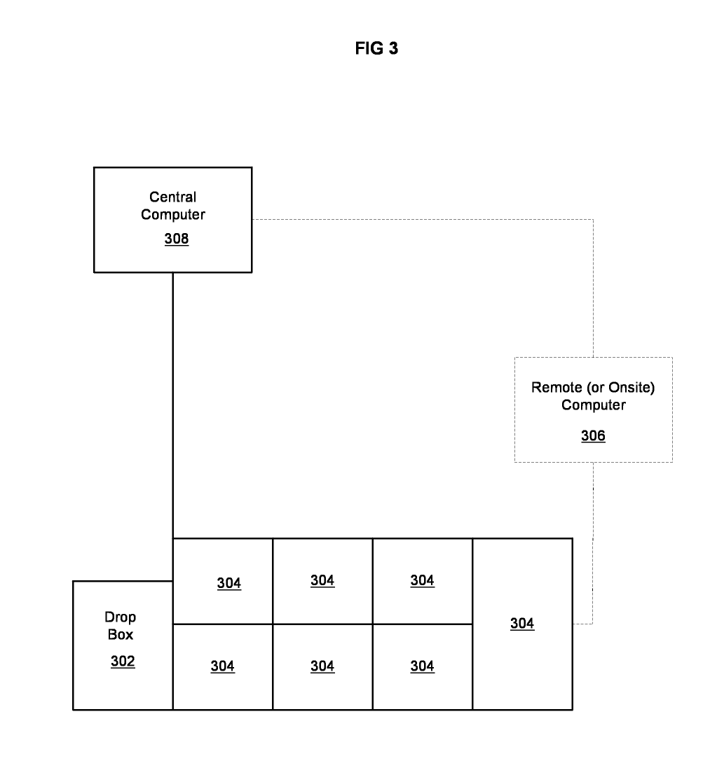

FIG. 3 is a diagram illustrating components of the disclosed pickup and delivery system described herein. Drop box 302 may be co-located with one or more lockers/lockboxes 304. Computer 306 may be located onsite with the drop box 302 and/or lockers/lockboxes 304 or it may be remotely located and in communication with the pickup and delivery system using a wireless, wired or backhaul connection. In some embodiments of the system, computer 306 is contemplated as being optional. Central computer 308 may be located remotely from the drop box 302 and lockers 304 and a communication network with the locker/drop box operation may be established using a wireless, wired or backhaul connection. Computers 306 and 308 each contain or are connected to memory (not shown) for storage of relevant data.

The steps of operation may be accomplished directly in hardware, software module executed by a processor or a combination thereof. The software module may reside in RAM memory, flash memory, ROM memory, EPROM memory, EEPROM memory, registers, a hard disk, a removable disk a CD-ROM or any form of storage memory.

The processor described herein may be implements with a digital signal processor, an application specific processor, a digital signal processor, and application specific processor a field programmable gate array or other programmable logic device.

Although the invention herein has been described with reference to particular embodiments, it is to be understood that these embodiments are merely illustrative of the principles and applications of the present invention. It is therefore to be understood that numerous modification may be made to the illustrative embodiments and the other arrangements may be devised without departing from the spirit and scope of the present invention as defined by the appended claims.

I claim:

1. A method for the pickup and deliver of items comprising:
receiving at least one package at a drop box;
reading information on a label attached to the at least one package;
notifying a service provider of the receipt of the at least one package;
sorting the at least one package according to a service provider;
electronically sending drop box unlock information to a service provider.

2. The method recited in claim 1 further comprising:
receiving , at a lockbox, a package with processed items;
generating an unlock code;
programming the lockbox to open in connection with the entry of the lockbox code at the lockbox;
electronically transmitting a lockbox number and the unlock code for the lockbox to a recipient; and
releasing the lockbox contents in connection with the entry of the unlock code at the lockbox.

3. The method as recited in claim 2 wherein a new lockbox code for the lockbox is generated after each receipt by the lockbox of a new package with processed items.

4. The method as recited in claim 2 wherein the electronically transmitting of the lockbox number is accomplished wirelessly in connection with using a transmitter.

5. The method as recited in claim 2 wherein the electronically transmitting of the lockbox number is accomplished in connection with using a wired connection between the lockbox and the recipient.

6. The method as recited in claim 2 wherein the electronically transmitting of the lockbox number is accomplished in connection with using the Internet.

7. The method as recited in claim 2 wherein the lockbox number and unlock code are provided to the recipient via a method via an email message.

8. The method as recited in claim 2 wherein the lockbox number and unlock code are provided to the recipient via a text message.

9. The method as recited in claim 2 wherein the unlock code is generated by a computer.

10. The method of claim 1 wherein the drop box unlock information is transmitted via an email message.

11. The method of claim 1 wherein the drop box unlock information is transmitted via text message.

12. The method of claim 2 wherein biometric information is used to program each unlock code.

13. A system for pickup and delivery of items comprising:
a drop box having an electronically controlled lock;
a plurality of lockboxes, each lockbox having an electronically controlled lock;
at least one computer, said computer being operable to generate unlock codes for the drop box and each lockbox of the plurality of lockboxes;
means for programming individual unlock codes into each lockbox of the plurality of lockboxes;
means for programming a code to unlock the drop box
means for transmitting unlock codes to the plurality of lockboxes and the drop box.

14. The system as recited in claim 13 which further includes means to photograph and record events involving the placement of items in and the removal of items from the drop box and lockboxes.

15. The system as recited in claim 13 which further includes means to accept payment for services requested for deposited items in the drop box.

16. The system of claim 13 which includes means to generate a label for items to be deposited within the drop box.

17. The system of claim 13 wherein means for transmitting unlock codes is accomplished via the Internet.

18. The system of claim 13 wherein he means for transmitting unlock codes is accomplished using wireless transmission.

19. The system of claim 13 which further includes means to detect the presence or absence of an item in the drop box.

20. The system of claim 13 wherein the at least computer is used to monitor the status of packages placed lockboxes.
